(19) United States
(12) Patent Application Publication
(10) Pub. No.: US 2026/0138444 A1
(43) Pub. Date: May 21, 2026

(54) VEHICLE AND METHOD OF DISPLAYING USER INPUTS

(71) Applicant: GM GLOBAL TECHNOLOGY OPERATIONS LLC, Detroit, MI (US)

(72) Inventors: Eric T. Hosey, Rochester Hills, MI (US); Matthew E. Gilbert-Eyres, Rochester Hills, MI (US); Russell A. Patenaude, Macomb Township, MI (US); Ronald A. Wehner, Grand Blanc, MI (US)

(73) Assignee: GM GLOBAL TECHNOLOGY OPERATIONS LLC, Detroit, MI (US)

(21) Appl. No.: 18/948,609

(22) Filed: Nov. 15, 2024

(51) Int. Cl. B60K 35/22

(52) U.S. Cl. CPC B60K 35/22

(57) ABSTRACT

A method of displaying a plurality of user inputs in a vehicle includes identifying a display timing criteria and a display component for each of the plurality of user inputs; developing a redundancy plan that includes an alternate display component for at least one of the plurality of user inputs; assigning a display priority for each of the plurality of user inputs based on the display timing criteria; ranking each of the plurality of user inputs according to the respective display priority to thereby develop a prioritization scheme; and displaying the plurality of user inputs in the vehicle according to the prioritization scheme and the redundancy plan. A vehicle includes a plurality of display components and a system having a communication bus and a plurality of electronic control units in communication with the plurality of display components via the communication bus.

### INTRODUCTION

The disclosure relates to a vehicle and to a method of displaying a plurality of user inputs in the vehicle.

A vehicle may receive inputs from a user of the vehicle by way of a physical component, such as a rotatable knob or a depressible button, or by way of a virtual control, such as an electronic button, slider, or toggle switch displayed on a screen. For example, the user may interact with the vehicle to change a user input such as speaker volume by turning a physical, rotatable knob or by touching an electronic volume control button on an infotainment touchscreen. Similarly, the user may input a request to summon emergency services to the vehicle by depressing a physical button or by selecting an electronic button. Although a location of physical components may remain fixed in the vehicle, in contrast, virtual controls may change positions on a touchscreen or locations within the vehicle depending on vehicle operating conditions and user preferences.

### SUMMARY

A method of displaying a plurality of user inputs in a vehicle includes identifying a display timing criteria and a display component for each of the plurality of user inputs and developing a redundancy plan that includes an alternate display component for at least one of the plurality of user inputs. The method also includes assigning a display priority for each of the plurality of user inputs based on the display timing criteria and ranking each of the plurality of user inputs according to the respective display priority to thereby develop a prioritization scheme. The method further includes displaying the plurality of user inputs in the vehicle according to the prioritization scheme and the redundancy plan.

In one aspect, identifying the display component may include specifying at least two electronic control units (ECUs) of the vehicle configured to control the display component.

In an additional aspect, assigning the display priority may include classifying the display timing criteria for each of the plurality of user inputs.

In another aspect, ranking may include prioritizing certain ones of the plurality of user inputs over other ones of the plurality of user inputs based on the respective display timing criteria and the respective display component for each of the plurality of user inputs to thereby develop the prioritization scheme.

In a further aspect, the method may further include assessing whether the display component is functional or non-functional for each of the plurality of user inputs and denoting at least one of a displayable user input that is able to be displayed on a functional display component according to the respective display timing criteria; and a non-displayable user input that is unable to be displayed on a non-functional display component according to the respective display timing criteria.

In one aspect, displaying may include, for the displayable user input, assessing whether another one of the plurality of user inputs is displayed on the functional display component. If the other one of the plurality of user inputs is not displayed on the functional display component, the method may include displaying the displayable user input on the functional display component according to the respective display timing criteria. If the other one of the plurality of user inputs is displayed on the functional display component, the method may include assessing which of the displayable user input and the other one of the plurality of user inputs has a higher display priority. If the displayable user input has the higher display priority, the method may include displaying the displayable user input on the functional display component. If the other one of the plurality of user inputs has the higher display priority, the method may include displaying the other one of the plurality of user inputs on the functional display component.

In an additional aspect, displaying may include, for the non-displayable user input, assessing whether the non-displayable user input has the alternate display component and, if so, whether the alternate display component is functional. If the non-displayable user input has the functional alternate display component, the method may include displaying the non-displayable user input on the functional alternate display component. If the non-displayable user input does not have the functional alternate display component, the method may include assessing whether the non-displayable user input has a replacement user input. If the non-displayable user input has the replacement user input, the method may include displaying the replacement user input. If the non-displayable user input does not have the replacement user input, the method may include denoting the non-displayable user input as unavailable.

In another aspect, denoting the non-displayable user input as unavailable may include offering an alternate user input.

In a further aspect, offering the alternate user input may include changing a function of non-displayable user input.

In one aspect, ranking may include modifying at least a portion of the prioritization scheme according to an instruction from an occupant of the vehicle.

In an additional aspect, identifying the display component may include assigning at least two display sub-components to each of the plurality of user inputs.

In another aspect, the method may further include identifying a plurality of display components for each of the plurality of user inputs.

In a further aspect, the method may further include detecting a location of an occupant within the vehicle.

In one aspect, identifying the display component may include selecting the display component based on the location of the occupant within the vehicle.

In another embodiment, a method of displaying a plurality of user inputs in a vehicle includes identifying a display timing criteria and a display component for each of the plurality of user inputs and assigning a display priority for each of the plurality of user inputs based on the display timing criteria. The method further includes assessing whether the display component is functional or non-functional for each of the plurality of user inputs, and denoting at least one of a displayable user input that is able to be displayed on a functional display component according to the respective display timing criteria and a non-displayable user input that is unable to be displayed on a non-functional display component according to the respective display timing criteria. After denoting the displayable user input, the method includes assessing whether another one of the plurality of user inputs is displayed on the functional display component. If the other one of the plurality of user inputs is not displayed on the functional display component, the method includes displaying the displayable user input on the functional display component according to the respective display timing criteria. If the other one of the plurality of user inputs is displayed on the functional display component, the method includes assessing which of the displayable user input and the other one of the plurality of user inputs has a higher display priority. If the displayable user input has the higher display priority, the method includes displaying the displayable user input on the functional display component. If the other one of the plurality of user inputs has the higher display priority, the method includes displaying the other one of the plurality of user inputs on the functional display component. After denoting the non-displayable user input, the method includes assessing whether the non-displayable user input has a functional alternate display component. If the non-displayable user input has the functional alternate display component, the method includes displaying the non-displayable user input on the functional alternate display component. If the non-displayable user input does not have the functional alternate display component, the method includes assessing whether the non-displayable user input has a replacement user input. If the non-displayable user input has the replacement user input, the method includes displaying the replacement user input. If the non-displayable user input does not have the replacement user input, the method includes denoting the non-displayable user input as unavailable.

In one aspect, the method may further include ensuring that the plurality of user inputs having a highest display priority are displayed without interruption.

A vehicle includes a plurality of display components each configured for displaying at least one of a plurality of user inputs and a system. The system includes a communication bus and a plurality of electronic control units (ECUs) in communication with the plurality of display components via the communication bus. Each of the plurality of ECUs is configured to execute an instruction set to access a display timing criteria for each of the plurality of user inputs and a display priority for each of the plurality of user inputs based on the display timing criteria. In addition, each of the plurality of ECUs is configured to execute an instruction set to inspect a redundancy plan that includes an alternate display component for at least one of the plurality of user inputs and a prioritization scheme that ranks each of the plurality of user inputs according to the respective display priority. Further, each of the plurality of ECUs is configured to execute an instruction set to control at least one of the plurality of display components to thereby display the plurality of user inputs in the vehicle according to the prioritization scheme and the redundancy plan.

In one aspect, at least two of the plurality of ECUs may be configured to communicate with one of the plurality of display components over the communication bus to thereby provide redundancy for one of the plurality of user inputs.

In an additional aspect, at least two of the plurality of ECUs may be configured to communicate with the alternate display component over the communication bus.

In another aspect, the vehicle may further include a plurality of power sources in electrical communication with the plurality of ECUs, wherein at least two of the plurality of power sources are in electrical communication with one of the plurality of ECUs.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a schematic illustration of a partial view of a passenger compartment of a vehicle having a plurality of display components each configured for displaying at least one of a plurality of user inputs.

FIG. 2 is a schematic illustration of a method of displaying the plurality of user inputs and executable by the vehicle of FIG. 1.

FIG. 3 is a schematic illustration of another embodiment of the method of FIG. 2.

### DETAILED DESCRIPTION

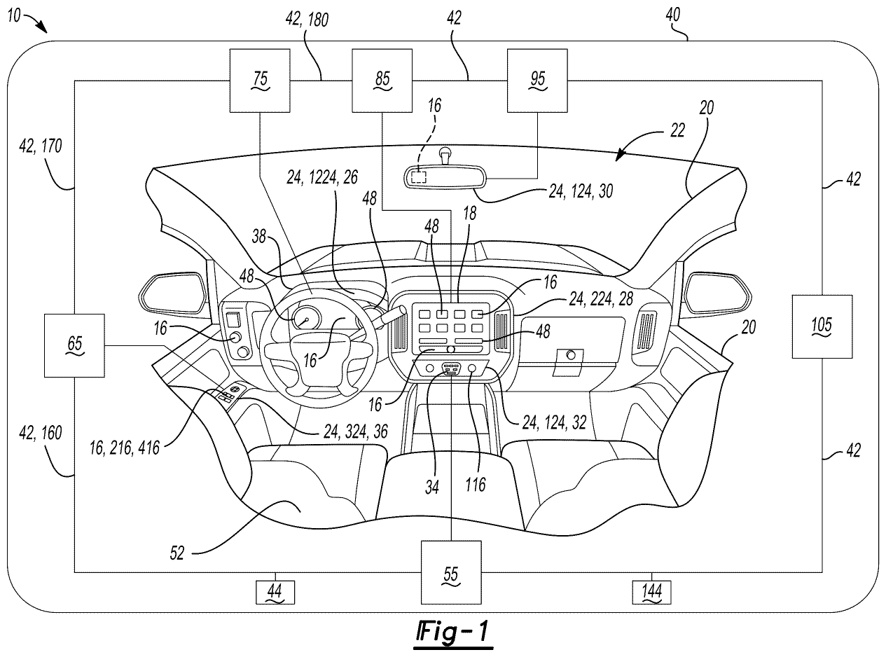

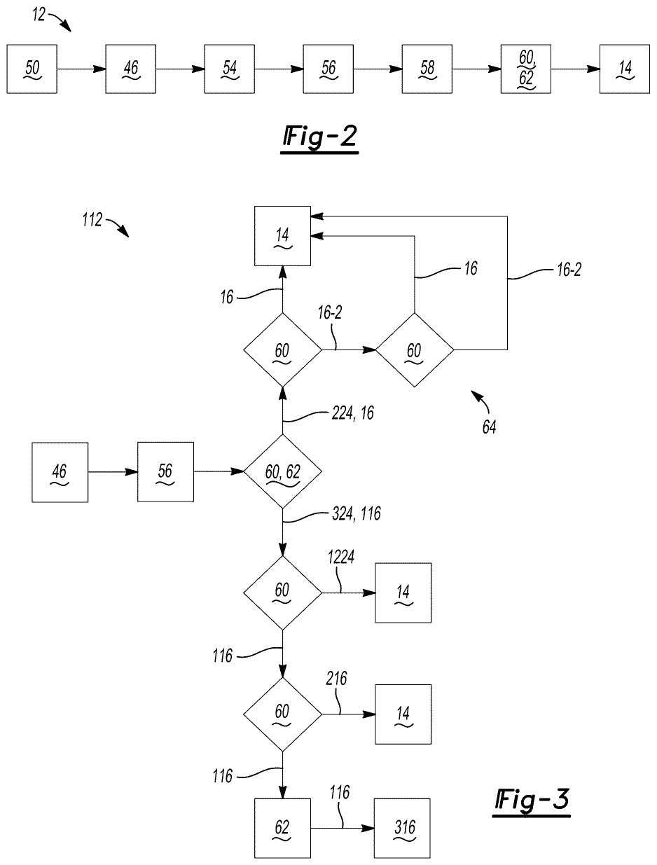

Referring to the Figures, wherein like reference numerals refer to like elements, a vehicle 10 (FIG. 1) and a method 12, 112 (FIGS. 2 and 3) of displaying 14 (FIGS. 2 and 3) a plurality of user inputs 16 (FIG. 1) in the vehicle 10 are shown generally. The vehicle 10 and method 12, 112 may be useful for applications requiring virtual or electronic user inputs 16, such as, for example, electronic buttons, sliders, and toggle switches displayed on a touchscreen 18 (FIG. 1), as a means of interfacing with a user or occupant of the vehicle 10. In particular, the method 12, 112 may allow certain virtual user inputs 16 to be both available and readily accessible to the user during certain events. More specifically, the method 12, 112 may be useful for prioritizing which virtual or electronic user inputs 16 are to remain easily accessible and displayed without interruption in the vehicle 10, and for ensuring that those virtual or electronic user inputs 16 are consistently available to the user, even when the vehicle 10 is disabled, damaged, or non-operational for travel.

In particular, and as set forth in more detail below, the method 12, 112 may identify important or required user inputs 16 and respective timing and display component criteria that dictate when and where the user inputs 16 are mandated or able to be displayed. Such timing and display component criteria may be used to develop a prioritization scheme to identify which user inputs 16 have highest display priority and to develop a redundancy plan to dictate actions when one or more of the user inputs 16 cannot be displayed under the timing and display component criteria.

As such, the method 12, 112 and vehicle 10 may be useful for automotive applications such as, but not limited to, internal combustion engine vehicles, electric vehicles, hybrid vehicles, and the like. For example, the vehicle 10 may be a motor vehicle powered by a motive power source including at least one of an internal combustion engine, an electric motor, and an energy storage device.

Further, the vehicle 10 may be configured for autonomous or automated driving in which the vehicle 10 may be controlled or driven by technology including hardware and software, whether remote to the vehicle 10 or onboard the vehicle 10, that is capable of driving the vehicle 10 without active physical control by a human operator. For example, autonomous or automated driving tasks may include, but are not limited to, object and event detection, recognition, and classification; object and event response; maneuver planning; steering, turning, lane-keeping, signaling, and lane changing; and acceleration and deceleration.

Alternatively, the method 12, 112 and vehicle 10 may be useful for non-automotive applications such as, but not limited to, aerospace, aviation, marine, mass transportation, agricultural, industrial, and rail applications. For example, the vehicle 10 may be, but is not limited to, a commercial vehicle, industrial vehicle, passenger vehicle, aircraft, watercraft, train, trolley, bus, or the like. It is also contemplated that the vehicle 10 may be a mobile platform, such as an airplane, all-terrain vehicle (ATV), boat, personal movement apparatus, robot, and the like to accomplish the purposes of this disclosure.

Referring now to FIG. 1, the vehicle 10 may include a body 20 that defines an interior passenger compartment 22 in which the occupant or user may sit and interact with the vehicle 10. For example, within the interior passenger compartment 22, the vehicle 10 includes a plurality of display components 24 each configured for displaying 14 at least one of the plurality of user inputs 16. The plurality of display components 24 may be selected from, but are not limited to, a touchscreen 18, a display screen, an instrument panel 26, an information unit such as a mobile phone (not shown), an entertainment unit such as a handheld tablet (not shown), an infotainment unit 28, a rearview mirror 30, a heating, ventilation, and air conditioning (HVAC) component or device 32, a defrost control panel 34, a window control unit 36, and the like. Further, each of the plurality of display components 24 may be capable of displaying 14 more than one of the plurality of user inputs 16, as set forth in more detail below.

To reiterate, each of the plurality of user inputs 16 may be a virtual control as opposed to a physical component. That is, in one non-limiting example, one of the plurality of user inputs 16 may be an electronic button that, when touched or selected on a touchscreen 18 along a dashboard d of the vehicle 10 or situated on the rearview mirror 30 of the vehicle 10, summons emergency services to the vehicle 10. In another non-limiting example, one of the plurality of user inputs 16 may be an electronic slider or volume control button situated on a touchscreen 18 of the vehicle 10. In another non-limiting example, one of the plurality of user inputs 16 may be an electronic window control situated on an armrest of the vehicle 10. In another non-limiting example, one of the plurality of user inputs 16 may be an electronic temperature control button for the HVAC device 32. In another non-limiting example, one of the plurality of user inputs 16 may be an electronic control button situated on a touchscreen 18 and configured to control windshield wiper blades (not shown) of the vehicle 10.

Referring again to FIG. 1, the vehicle 10 also includes a system 40 configured for communicating with and controlling the plurality of display components 24 to thereby display the plurality of user inputs 16. More specifically, the system 40 includes a communication bus 42 and a plurality of electronic control units (ECUs) 55, 65, 75, 85, 95, 105 in communication with the plurality of display components 24 via the communication bus 42. The communication bus 42 may be a low-voltage communication bus 42, such as a controller area network (CAN) bus, through which the plurality of application-specific ECUs 55, 65, 75, 85, 95, 105 are connected. While six ECUs or control modules 55, 65, 75, 85, 95, 105 are shown for illustrative simplicity in FIG. 1, fewer or additional ECUs 55, 65, 75, 85, 95, 105 may be used on the communication bus 42 within the scope of the disclosure.

Each ECU 55, 65, 75, 85, 95, 105 may be configured to execute computer-readable instructions embodying the method 12, 112 (FIGS. 2 and 3) for displaying 14 the plurality of user inputs 16 in the vehicle 10 using available network data. Each ECU 55, 65, 75, 85, 95, 105 may be an inboard control tool, i.e., located internal or on the vehicle 10, and may be used to control display of the plurality of user inputs 16 according to the method 12, 112 described in further detail below with respect to FIGS. 2 and 3. While a differential CAN bus having high-side and low-side voltage data is described for illustrative consistency, the present disclosure is not limited to vehicular embodiments in general or CAN-applications in particular, but is rather applicable to systems 40 of various types used to display the plurality of user inputs 16 and effect communication between multiple ECUs 55, 65, 75, 85, 95, 105 over the communication bus 42.

By way of a general description, the CAN bus protocol may allow connected ECUs 55, 65, 75, 85, 95, 105 and display components 24, 124 to communicate with each other with low-voltage data signals within the vehicle 10. The CAN bus protocol may use a two-wire balanced signaling scheme as defined by ISO-11898-2, which specifies a two-wire differential in which a number of nodes is limited by an electrical bus load. The two wires of a CAN bus are identified as the CAN high-side (CAN_{H}) and CAN low-side (CAN_{L}). In an exemplary CAN embodiment, a characteristic impedance of the communication bus 42 may be 120Ω and a common mode voltage may range from −2 VDC on CAN_{L} to +7 VDC on CAN_{H}. The CAN_{L} voltage may generally be in the range of 1.5 VDC −2.5 VDC and CAN_{H} voltage may range from 2.5 VDC −3.5 VDC. Further, each node on the communication bus 42 may send and receive messages, but not simultaneously. That is, each received message may include a bit identifier that represents the priority of the message, i.e., an 11-bit identifier (CAN 2.0A) or an extended 29-bit identifier (CAN 2.0B).

Further, the CAN bus protocol also specifies two logical states, i.e., recessive and dominant. A differential voltage may be used to represent the recessive and dominant states (i.e., bits). In the recessive state (logical state=1), the differential voltage on CAN_{H} and CAN_{L} may be less than a minimum threshold. In the dominant state (logical state=0), the differential voltage may be greater than the minimum threshold. Data may be transmitted along the communication bus 42 as message packets, commonly referred to as frames, with each frame separated from prior frames by a bit field called an inter-frame space. The inter-space frame may consist of at least three consecutive recessive bits. Thus, following receipt of the consecutive recessive bits, receipt of a dominant bit may be regarded by an ECU 55, 65, 75, 85, 95, 105 as a start of the next frame.

In the particular configuration shown in FIG. 1, the ECUs 55, 65, 75, 85, 95, 105 may be configured to receive or forward data over the communication bus 42. To this end, each ECU 55, 65, 75, 85, 95, 105 may also be electrically connected to respective power and ground grids (not shown). Each ECU 55, 65, 75, 85, 95, 105 may transmit and receive bit messages over the communication bus 42, with such messages conforming to a predetermined message format. The communication bus 42 of FIG. 1 may therefore include a plurality of communications links, such as a first communications link 160 between ECUs 55 and 65, a second communications link 170 between ECUs 65 and 75, a third communications link 180 between ECUs 75 and 85, and the like.

While not limited to a specific system 40 or functional embodiment, the ECUs 55, 65, 75, 85, 95, 105 may be variously embodied in an example vehicle configuration as a telematics control unit or module, an infotainment head unit control unit or module, an instrument panel cluster control unit or module, a rear seat entertainment control unit or module, an engine control unit or module, a transmission control unit or module, a body control unit or module, a battery control unit or module, and the like. In addition, one or more of the ECUs 105 may be considered a host ECU that is configured for routing, controlling, or analyzing messages and traffic along the communication bus 42.

Although not shown, the power grid may include one or more power sources 44, 144, e.g., a battery or generator, in electrical communication with the plurality of ECUs 55, 65, 75, 85, 95, 105 to provide electric power to the ECUs 55, 65, 75, 85, 95, 105. In some embodiments, at least two of the plurality of power sources 44, 144 may be in electrical communication with one of the plurality of ECUs 55, 65, 75, 85, 95, 105 so as to provide redundancy or backup power to the ECU 55, 65, 75, 85, 95, 105. That is, each ECU 55, 65, 75, 85, 95, 105 may be in electrical communication with two power sources 44, 144. Such redundancy may ensure that certain ones of the plurality of user inputs 16 may also be displayed within the vehicle 10 without interruption if desired or mandated. Although not shown, the ground grid may include a vehicle ground to provide electrical ground to the ECUs 55, 65, 75, 85, 95, 105. Other arrangements for distribution of communications, power, and ground for the ECUs 55, 65, 75, 85, 95, 105 and the communication bus 42 may be employed to similar effect.

The ECUs 55, 65, 75, 85, 95, 105 may be configured as various combinations of one or more of processors, e.g., Application Specific Integrated Circuits (ASICs), electronic circuits, central processing units, or microprocessors, and sufficient amounts and configurations of associated memory, including read only, programmable read only, random access, optical, and/or magnetic memory. The ECUs 55, 65, 75, 85, 95, 105 may execute one or more software or firmware programs to execute the method 12, 112 to provide the described functionality.

More specifically, and as set forth in more detail below, each of the plurality of ECUs 55, 65, 75, 85, 95, 105 may be configured to execute an instruction set to: access a display timing criteria for each of the plurality of user inputs 16 and a display priority for each of the plurality of user inputs 16 based on the display timing criteria; inspect a redundancy plan that includes an alternate display component 124 (FIG. 1) for at least one of the plurality of user inputs 16 and a prioritization scheme that ranks each of the plurality of user inputs 16 according to the respective display priority; and control at least one of the plurality of display components 24 to thereby display the plurality of user inputs 16 in the vehicle 10 according to the prioritization scheme and the redundancy plan.

In addition, as described with continued reference to FIG. 1, at least two of the plurality of ECUs 55, 65, 75, 85, 95, 105 may be configured to communicate with one of the plurality of display components 24 over the communication bus 42 to thereby provide redundancy for one of the plurality of user inputs 16. For example, and as set forth in more detail below, two ECUs 55, 65, 75, 85, 95, 105, such as an infotainment ECU or module and a telematics ECU or module of the vehicle 10, may be configured to communicate with one display component 24, such as a touchscreen 18, over the communication bus 42 to provide redundancy for one user input 16, such as a virtual emergency services user input 16. Similarly, two ECUs 55, 65, 75, 85, 95, 105, such as an instrument panel ECU or module and a rear seat entertainment ECU or module, may be configured to communicate with a window control display component 24 to thereby provide redundancy for a window control virtual button or user input 16. Such redundancy may ensure that certain ones of the plurality of user inputs 16 may be continuously displayed within the vehicle 10 if desired or mandated.

Further, at least two of the plurality of ECUs 55, 65, 75, 85, 95, 105 may be configured to communicate with the alternate display component 124 over the communication bus 42. That is, as set forth in more detail below, if a particular user input 16 cannot be displayed on a certain, first-choice display component 24 and should instead be displayed on the alternate display component 124 according to the redundancy plan, each of the two ECUs 55, 65, 75, 85, 95, 105 may communicate with the alternate display component 124 to thereby provide redundancy for the two ECUs 55, 65, 75, 85, 95, 105 and redundancy for the first-choice display component 24. Likewise, such redundancy may ensure that certain ones of the plurality of user inputs 16 may be continuously displayed within the vehicle 10 if desired or mandated.

Referring now to FIG. 2, the method 12 of displaying 14 the plurality of user inputs 16 in the vehicle 10 includes identifying 46 the display timing criteria and the display component 24 for each of the plurality of user inputs 16. The display timing criteria may represent a timing of when or how often to display each of the plurality of user inputs 16 or may represent required conditions that may be present before or while the plurality of user inputs 16 are displayed. By way of non-limiting examples, a display timing criteria may be identified, classified, or listed as “always available”, “temperature within passenger cabin 22 exceeds threshold”, “condensation detected exterior to vehicle 10”, “volume within passenger compartment 22 exceeds threshold”, and the like.

Further, the method 12 may also include identifying 46 a plurality of display components 24 (FIG. 1) for each of the plurality of user inputs 16. That is, identifying 46 the plurality of display components 24 may include selecting a desired or first-choice display component 24 and the alternate display component 124 for a given user input 16. For example, the desired or first-choice display component 24 for a virtual window control user input 16 may be the touchscreen 18 of the infotainment unit 28 of the vehicle 10 and the alternate display component 124 for the virtual window control user input 16 may be a rear seat entertainment device (not shown).

In addition, identifying 46 the display component 24 may also include assigning at least two display sub-components 48 (FIG. 1) to each of the plurality of user inputs 16. That is, a display sub-component 48 may be a portion of a given display component 24. For example, a left, upper quadrant of the infotainment touchscreen 18 may be one display sub-component 48 of the display component 24 and a right, lower quadrant of the infotainment touchscreen 18 may be a second display sub-component 48 of the display component 24. Alternatively, a first instrument cluster of the instrument panel 26 may be one display sub-component 48 of the display component 24 along the dashboard 38 and a second instrument cluster of the instrument panel 26 may be a second display sub-component 48 of the display component 24 along the dashboard 38. As such, if one display sub-component 48 is unavailable due to electrical anomalies, damage, or malfunctioning hardware, the second display sub-component 48 may provide redundancy for display of the user input 16.

Identifying 46 the display component 24 for each of the plurality of user inputs 16 may also include specifying at least two ECUs 55, 65, 75, 85, 95, 105 (FIG. 1) of the vehicle 10 configured to control the display component 24. For example, the at least two ECUs 55, 65, 75, 85, 95, 105 configured to control the virtual window control user input 16 may be an infotainment control module or unit and an instrument panel control module or unit. As such, if one ECU 55, 65, 75, 85, 95, 105 is unavailable due to electrical anomalies, damage, or corrupted software, the second ECU 55, 65, 75, 85, 95, 105 may provide redundancy for display of the user input 16.

Referring again to FIG. 2, the method 12 may further include detecting 50 a location of an occupant or user within the vehicle 10. For example, detecting 50 may include sensing a presence or weight of the occupant on a seat 52 (FIG. 1) via a sensor (not shown). As such, detecting 50 may include ascertaining how many occupants are situated within the passenger compartment 22 of the vehicle 10, and where the occupants are specifically positioned within the vehicle 10, e.g., in a front seat or a rear seat, and on a driver's side or a passenger side of the vehicle 10. Therefore, identifying 46 the display component 24 for each of the plurality of user inputs 16 may include selecting the display component 24 based on the location of the occupant within the vehicle 10. For example, if an occupant is seated in a rear, passenger-side seat of the vehicle 10, a touchscreen 18 of a rear infotainment device or component situated in a seat headrest directly in front of the seated occupant may be selected as the display component 24 for a virtual HVAC temperature control user input 16 or an emergency services virtual user input 16.

Referring again to FIG. 2, the method 12 also includes developing 54 the redundancy plan that includes the alternate display component 124 for at least one of the plurality of user inputs 16. That is, the redundancy plan may specify the alternate display component 124 so that if a particular user input 16 cannot be displayed on a certain, first-choice display component 24, the user input 16 may be displayed elsewhere. As such, the redundancy plan may ensure that each user input 16 having a respective alternate display component 124 is available for uninterrupted display if desired. As a tangible example, it may be important for a virtual emergency services user input 16 to be displayed without interruption on the infotainment touchscreen display component 24. If the infotainment touchscreen display component 24 becomes inoperable or damaged, the virtual emergency services user input 16 may be moved to be displayed on the instrument panel alternate display component 124.

As described with continued reference to FIG. 2, the method 12 also includes assigning 56 a display priority for each of the plurality of user inputs 16 based on the display timing criteria. As a non-limiting example, user inputs 16 that include the display timing criteria of “always available” may have the display priority of “1”. User inputs 16 that include the display timing criteria of “temperature within passenger cabin 22 exceeds threshold” may be displayed automatically under certain conditions and may have the display priority of “2”. Similarly, user inputs 16 that include the display timing criteria of “condensation detected exterior to vehicle 10” may have the display priority of “3”. User inputs 16 that include the display timing criteria of “volume within passenger compartment 22 exceeds threshold” may have the display priority of “4”. As such, assigning 56 the display priority may include classifying the display timing criteria, for example according to importance, user comfort, environmental conditions, or other user-defined considerations, for each of the plurality of user inputs 16.

The method 12 illustrated generally in FIG. 2 also includes ranking 58 each of the plurality of user inputs 16 according to the respective display priority to thereby develop a prioritization scheme. For example, ranking 58 may include prioritizing certain ones of the plurality of user inputs 16 over other ones of the plurality of user inputs 16 based on the respective display timing criteria and the respective display component 24 for each of the plurality of user inputs 16 to thereby develop the prioritization scheme. That is, for the non-limiting example set forth above, user inputs 16 having a display priority of “1” may have a higher ranking in the prioritization scheme than user inputs 16 having a display priority of “4”. As such, if display conflicts exist between two user inputs 16, the user input 16 having the higher display priority in the prioritization scheme may be displayed on a given display component 24.

Ranking 58 may also include modifying at least a portion of the prioritization scheme according to an instruction from the occupant of the vehicle 10. That is, in some instances, the occupant may prefer to rank a temperature control user input 16 higher than a volume control user input 16, for example. As such, for certain user inputs 16 that are not needed for efficient or intended operation of the vehicle 10, ranking 58 the plurality of user inputs 16 to develop the prioritization scheme may include changing a respective display priority of the user inputs 16 according to occupant preferences.

Referring again to FIG. 2, the method 12 also includes displaying 14 the plurality of user inputs 16 in the vehicle 10 according to the prioritization scheme and the redundancy plan. That is, displaying 14 may include accessing or inspecting or checking the prioritization scheme and redundancy plan and providing the plurality of user inputs 16 in the vehicle 10 accordingly. More specifically, one or more of the ECUs 55, 65, 75, 85, 95, 105 may read the prioritization scheme and the redundancy plan and control one or more display components 24 to thereby display the plurality of user inputs 16.

In greater detail, and as described with continued reference to FIG. 2, the method 12 may further include assessing 60 whether the display component 24 is functional or non-functional for each of the plurality of user inputs 16 and denoting 62 at least one of: a displayable user input 16 that is able to be displayed on a functional display component 224 (FIGS. 1 and 3) according to the respective display timing criteria; and a non-displayable user input 116 (FIGS. 1 and 3) that is unable to be displayed on a non-functional display component 324 (FIGS. 1 and 3) according to the respective display timing criteria. That is, at times, a display component 24 may be non-functional due to, for example, hardware or software issues, damage to the display component 24, damage to or malfunction of one or more ECUs 55, 65, 75, 85, 95, 105 or the communication bus 42, user error, and the like, and may be unable to display the intended user input 16. Assessing 60 may include, for example, detecting whether the display component 24 is functional or non-functional using at least one of a heartbeat message such as a periodic communication signal to verify a health and operational status of the display component 24, diagnostics, and power readings for the display component 24.

In addition, displaying 14 may include, for the displayable user input 16, assessing 60 whether another one of the plurality of user inputs 16-2 (FIG. 3) is displayed on the functional display component 224. For example, in certain instances, a user input 16 having a higher display priority may already be displayed on the functional display component 224. If the other one of the plurality of user inputs 16-2 is not displayed on the functional display component 224, the method 12 may include displaying 14 the displayable user input 16 on the functional display component 224 according to the respective display timing criteria.

As a tangible example, for a displayable HVAC control virtual user input 16 that is intended to be displayed on the functional infotainment touchscreen display component 224, the method 12 may include assessing 60 whether another user input 16-2, e.g., a displayable window control virtual user input 16, is instead displayed on the functional infotainment touchscreen display component 224. If the other user input 16-2, i.e., the displayable window control virtual user input 16, is not displayed on the functional infotainment touchscreen display component 224, the method 12 may include displaying 14 the intended displayable HVAC control virtual user input 16 on the functional infotainment touchscreen display component 224 according to the respective display timing criteria.

However, if the other one of the plurality of user inputs 16-2 is displayed on the functional display component 224, the method 12 may include assessing 60 which of the displayable user input 16 and the other one of the plurality of user inputs 16-2 has a higher display priority. That is, the method 12 may include comparing the respective display priorities to determine which user input 16, 16-2 outranks the other in the prioritization scheme. If the displayable user input 16 has the higher display priority, the method 12 may include displaying 14 the displayable user input 16 on the functional display component 224. If the other one of the plurality of user inputs 16-2 has the higher display priority, the method 12 may include displaying 14 the other one of the plurality of user inputs 16-2 on the functional display component 224.

That is, for the example set forth above, if the displayable window control virtual user input 16-2 is instead displayed on the functional infotainment touchscreen display component 216 instead of the intended displayable HVAC control virtual user input 16, the method 12 may include assessing 60 which of the user inputs 16, 16-2 has the higher display priority and displaying that user input 16, 16-2, i.e., the displayable window control virtual user input 16-2 or the displayable HVAC control virtual user input 16.

Referring again to FIG. 2, displaying 14 may also include, for the non-displayable user input 116 (FIG. 1), assessing 60 whether the non-displayable user input 116 has the alternate display component 124, and, if so, whether the alternate display component 124 is functional. That is, the method 12 may include checking the redundancy plan for the non-displayable user input 116 to determine whether a backup or alternate display component 124 exists for the desired non-displayable user input 116. If the non-displayable user input 116 has the functional alternate display component 1224 (FIGS. 1 and 3), the method 12 may include displaying 14 the non-displayable user input 116 on the functional alternate display component 1224, thereby rendering the non-displayable user input 116 displayable. The method 12 may also include notifying or alerting the user, e.g., with an audible chime or visual message, that the non-displayable user input 116 does or does not have the functional alternate display component 1224.

Therefore, with continued reference to the example set forth above, if the HVAC control virtual user input 16 that is intended to be displayed on the functional infotainment touchscreen display component 224 is non-displayable, the method 12 may include assessing 60 whether the non-displayable HVAC control virtual user input 116 has an alternate display component 124, e.g., an instrument panel display component 124 rather than the intended infotainment touchscreen display component 224, and then displaying 14 the non-displayable HVAC control virtual user input 116 on the alternate instrument panel display component 124.

However, if the non-displayable user input 116 does not have the functional alternate display component 1224, the method 12 may include assessing 60 whether the non-displayable user input 116 has a replacement user input 216 (FIGS. 1 and 3). That is, even if the alternate display component 124 (FIG. 1) is not functional, the method 12 may include replacing the non-displayable user input 116 with another replacement user input 216. For example, if the instrument panel display component 124 is not available as the functional alternate display component 1224, the method 12 may include assessing 60 whether the replacement user input 216 exists. The method 12 may also include notifying the user, e.g., with an audible chime or visual message, that the replacement user input 216 is or is not available.

For example, if the non-displayable HVAC control virtual user input 116 does not have the functional alternate instrument panel display component 1224, the method 12 may include assessing 60 whether a replacement user input 216 exists, such as perhaps a virtual window control user input 16 to change the temperature of the passenger compartment 22.

For the method 12, if the non-displayable user input 116 has the replacement user input 216 (FIG. 1), the method 12 may include displaying 14 the replacement user input 216. Alternatively, if the non-displayable user input 116 does not have the replacement user input 216, the method 12 may include denoting 62 (FIG. 2) the non-displayable user input 116 as unavailable 316 (FIG. 3), e.g., with an audible chime or visual message.

Further, in some instances, denoting 62 the non-displayable user input 116 as unavailable 316 may include offering an alternate user input 416 (FIG. 1). For example, the vehicle 10 may present a message or indication, e.g., visually, audibly, and/or haptically, to the user or occupant that the original non-displayable user input 116 is unavailable 316 and offer the alternate user input 416 instead. In particular, in some examples, offering the alternate user input 416 may include changing a function of the originally-intended non-displayable user input 116.

For example, if there is no way to successfully display the non-displayable user input 116, the method 12 may include commandeering functionality of another displayable user input 16. As a tangible example, if the HVAC control virtual user input 16 is non-displayable, the method 12 may include changing a function of the virtual window control user input 16 that is displayable such that the virtual window control user input 16 may be used by the occupant to instead control the HVAC display component 24. Alternatively, if the virtual emergency services user input 16 is unavailable 316, the method 12 may include prompting the occupant by displaying an available, displayable, and functional virtual window control user input 16 to instead function as the user input 16 that when touched or selected triggers contact with emergency services. That is, the method 12 may include finding a different user input 16 that is functional and displayable and then changing the functionality of that user input 16 to match the functionality of the non-displayable user input 116.

Therefore, in summary, the method 12 may ensure that user inputs 16 having the highest display priority are displayed and available under every vehicle condition. As one non-limiting example, a virtual emergency services user input 16 may have the highest display priority and may be required to be displayed and available under every vehicle condition. Secondarily, an HVAC control user input 16 may be required to be displaced when the passenger compartment 22 is too hot or too cold. If these user inputs 16 are attempting to occupy the same space, i.e., be displayed in the same location on the same display component 24, the HVAC control user input 16 would move to a next best display component 24 according to the prioritization scheme and redundancy plan.

Similarly, if every display component 24 for the HVAC control user input 16 is currently being used by a user input 16 having a higher display priority or are unavailable due to malfunction or damage, the replacement user input 216 (FIG. 1) may be displayed in another location, i.e., on another display component 24, such as a window control display component 24.

In another embodiment described with reference to FIG. 3, the method 112 of displaying 14 the plurality of user inputs 16 in the vehicle 10 includes identifying 46 the display timing criteria and the display component 24 for each of the plurality of user inputs 16. Further, the method 112 includes assigning 56 the display priority for each of the plurality of user inputs 16 based on the display timing criteria. The method 112 also includes assessing 60 whether the display component 24 is functional or non-functional for each of the plurality of user inputs 16 and denoting 62 at least one of: the displayable user input 16 that is able to be displayed on the functional display component 224 according to the respective timing criteria, and the non-displayable user input 116 that is unable to be displayed on the non-functional display component 324 according to the respective timing criteria.

After denoting 62 the displayable user input 16, the method 112 includes assessing 60 whether another one of the plurality of user inputs 16-2 is displayed on the functional display component 224. If the other one of the plurality of user inputs 16-2 is not displayed on the functional display component 224, the method 112 includes displaying 14 the displayable user input 16 on the functional display component 224 according to the respective timing criteria. If the other one of the plurality of user inputs 16-2 is displayed on the functional display component 224, the method 112 includes assessing 60 which of the displayable user input 16 and the other one of the plurality of user inputs 16-2 has a higher display priority.

If the displayable user input 16 has the higher display priority, the method 112 includes displaying 14 the displayable user input 16 on the functional display component 224. If the other one of the plurality of user inputs 16-2 has the higher display priority, the method 112 includes displaying 14 the other one of the plurality of user inputs 16-2 on the functional display component 224.

After denoting 62 the non-displayable user input 116, the method 112 includes assessing 60 whether the non-displayable user input 116 has the functional alternate display component 1224. If the non-displayable user input 116 has a functional alternate display component 1224, the method 112 includes displaying 14 the non-displayable user input 16 on the functional alternate display component 1224.

However, if the non-displayable user input 116 does not have the functional alternate display component 1224, the method 112 includes assessing 60 whether the non-displayable user input 116 has the replacement user input 216. If the non-displayable user input 116 has the replacement user input 216, the method 112 includes displaying 14 the replacement user input 216. If the non-displayable user input 116 does not have the replacement user input 216, the method 112 includes denoting 62 the non-displayable user input 116 as unavailable 316. As such, the method 112 may further include ensuring 64 that the plurality of user inputs 16 having a highest display priority are displayed without interruption. That is, ensuring 64 may allow the virtual user inputs 16 to be available and easily accessible to the occupant of the vehicle 10.

Therefore, in summary, the method 12, 112 may ensure availability of vehicle features and user inputs 16, prioritize which virtual or electronic user inputs 16 are to remain consistently displayed, and ensure that at least one of the plurality of user inputs 16 is consistently available to the user of the vehicle 10 without interruption, even when the vehicle 10 is disabled, damaged, or non-operational for travel. That is, advantageously, the method 12, 112 may allow certain virtual user inputs 16 to be available and easily accessible to a user or occupant of the vehicle 10 during certain events. Further, the method 12, 112 may provide redundancy with respect to power sources 44, 144, ECUs 55, 65, 75, 85, 95, 105, display components 24, and user inputs 16. Further, the method 12, 112 and vehicle 10 may enable compliance with various jurisdictional directives and provide flexibility with respect to user interfaces and preferences.

The described embodiments of the present disclosure are intended to serve as non-limiting examples, and other embodiments may take various and alternative forms. In addition, the appended drawings are not necessarily to scale, and may present a somewhat simplified representation of various features of the present disclosure, including, for example, specific dimensions, orientations, locations, and shapes. Details associated with such features will be determined in part by the intended application and use environment of the described embodiments.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function. In addition, the use of ordinals such as first, second and third does not necessarily imply a ranked sense of order, but rather may merely distinguish between multiple instances of an act or structure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A method of displaying a plurality of user inputs in a vehicle, the method comprising:
identifying a display timing criteria and a display component for each of the plurality of user inputs;
developing a redundancy plan that includes an alternate display component for at least one of the plurality of user inputs;
assigning a display priority for each of the plurality of user inputs based on the display timing criteria;
ranking each of the plurality of user inputs according to the respective display priority to thereby develop a prioritization scheme; and
displaying the plurality of user inputs in the vehicle according to the prioritization scheme and the redundancy plan.

2. The method of claim 1, wherein identifying the display component includes specifying at least two electronic control units (ECUs) of the vehicle configured to control the display component.

3. The method of claim 1, wherein assigning the display priority includes classifying the display timing criteria for each of the plurality of user inputs.

4. The method of claim 1, wherein ranking includes prioritizing certain ones of the plurality of user inputs over other ones of the plurality of user inputs based on the respective display timing criteria and the respective display component for each of the plurality of user inputs to thereby develop the prioritization scheme.

5. The method of claim 4, further including assessing whether the display component is functional or non-functional for each of the plurality of user inputs and denoting at least one of:
a displayable user input that is able to be displayed on a functional display component according to the respective display timing criteria; and
a non-displayable user input that is unable to be displayed on a non-functional display component according to the respective display timing criteria.

6. The method of claim 5, wherein displaying includes, for the displayable user input:
assessing whether another one of the plurality of user inputs is displayed on the functional display component;
if the other one of the plurality of user inputs is not displayed on the functional display component, displaying the displayable user input on the functional display component according to the respective display timing criteria; and
if the other one of the plurality of user inputs is displayed on the functional display component, assessing which of the displayable user input and the other one of the plurality of user inputs has a higher display priority;
if the displayable user input has the higher display priority, displaying the displayable user input on the functional display component; and
if the other one of the plurality of user inputs has the higher display priority, displaying the other one of the plurality of user inputs on the functional display component.

7. The method of claim 5, wherein displaying includes, for the non-displayable user input:
assessing whether the non-displayable user input has the alternate display component and, if so, whether the alternate display component is functional;
if the non-displayable user input has the functional alternate display component, displaying the non-displayable user input on the functional alternate display component; and
if the non-displayable user input does not have the functional alternate display component, assessing whether the non-displayable user input has a replacement user input;
if the non-displayable user input has the replacement user input, displaying the replacement user input; and
if the non-displayable user input does not have the replacement user input, denoting the non-displayable user input as unavailable.

8. The method of claim 7, wherein denoting the non-displayable user input as unavailable includes offering an alternate user input.

9. The method of claim 8, wherein offering the alternate user input includes changing a function of non-displayable user input.

10. The method of claim 1, wherein ranking includes modifying at least a portion of the prioritization scheme according to an instruction from an occupant of the vehicle.

11. The method of claim 1, wherein identifying the display component includes assigning at least two display sub-components to each of the plurality of user inputs.

12. The method of claim 1, further including identifying a plurality of display components for each of the plurality of user inputs.

13. The method of claim 1, further including detecting a location of an occupant within the vehicle.

14. The method of claim 13, wherein identifying the display component includes selecting the display component based on the location of the occupant within the vehicle.

15. A method of displaying a plurality of user inputs in a vehicle, the method comprising:
identifying a display timing criteria and a display component for each of the plurality of user inputs;
assigning a display priority for each of the plurality of user inputs based on the display timing criteria;
assessing whether the display component is functional or non-functional for each of the plurality of user inputs and denoting at least one of:
a displayable user input that is able to be displayed on a functional display component according to the respective display timing criteria; and
a non-displayable user input that is unable to be displayed on a non-functional display component according to the respective display timing criteria;
after denoting the displayable user input:
assessing whether another one of the plurality of user inputs is displayed on the functional display component;
if the other one of the plurality of user inputs is not displayed on the functional display component, displaying the displayable user input on the functional display component according to the respective display timing criteria; and
if the other one of the plurality of user inputs is displayed on the functional display component, assessing which of the displayable user input and the other one of the plurality of user inputs has a higher display priority;
if the displayable user input has the higher display priority, displaying the displayable user input on the functional display component; and
if the other one of the plurality of user inputs has the higher display priority, displaying the other one of the plurality of user inputs on the functional display component; and
after denoting the non-displayable user input:
assessing whether the non-displayable user input has a functional alternate display component;
if the non-displayable user input has the functional alternate display component, displaying the non-displayable user input on the functional alternate display component; and
if the non-displayable user input does not have the functional alternate display component, assessing whether the non-displayable user input has a replacement user input;
if the non-displayable user input has the replacement user input, displaying the replacement user input; and
if the non-displayable user input does not have the replacement user input, denoting the non-displayable user input as unavailable.

16. The method of claim 15, further including ensuring that the plurality of user inputs having a highest display priority are displayed without interruption.

17. A vehicle comprising:
a plurality of display components each configured for displaying at least one of a plurality of user inputs; and
a system including:
a communication bus; and
a plurality of electronic control units (ECUs) in communication with the plurality of display components via the communication bus, wherein each of the plurality of ECUs is configured to execute an instruction set to:
access:
a display timing criteria for each of the plurality of user inputs; and
a display priority for each of the plurality of user inputs based on the display timing criteria;
inspect:
a redundancy plan that includes an alternate display component for at least one of the plurality of user inputs; and
a prioritization scheme that ranks each of the plurality of user inputs according to the respective display priority; and
control at least one of the plurality of display components to thereby display the plurality of user inputs in the vehicle according to the prioritization scheme and the redundancy plan.

18. The vehicle of claim 17, wherein at least two of the plurality of ECUs are configured to communicate with one of the plurality of display components over the communication bus to thereby provide redundancy for one of the plurality of user inputs.

19. The vehicle of claim 17, wherein at least two of the plurality of ECUs are configured to communicate with the alternate display component over the communication bus.

20. The vehicle of claim 17, further including a plurality of power sources in electrical communication with the plurality of ECUs, wherein at least two of the plurality of power sources are in electrical communication with one of the plurality of ECUs.
